(19) United States
(12) Patent Application Publication
(10) Pub. No.: US 2025/0199844 A1
(43) Pub. Date: Jun. 19, 2025

(54) SIMULATING LOAD FOR A LOAD TEST

(71) Applicant: RAKUTEN MOBILE, INC., Tokyo (JP)

(72) Inventors: Anshul DUBEY, Tokyo (JP); Benjamin WINIARSKI, Tokyo (JP)

(73) Assignee: RAKUTEN MOBILE, INC., Tokyo (JP)

(21) Appl. No.: 18/539,429

(22) Filed: Dec. 14, 2023

(51) Int. Cl. G06F 9/46; G06F 16/2455

(52) U.S. Cl. CPC G06F 9/466; G06F 16/24565

(57) ABSTRACT

Example embodiments of the present disclosure relate to simulating load for a load test. According to embodiments, a system may include a load simulator. The load simulator may be configured to: generate at least one first transaction request associated with at least one first transaction for modifying at least one first entry in at least one database; provide, to the at least one database via a direct interface, the at least one first transaction request; and receive, from the at least one database via the direct interface, information associated with at least one second transaction for modifying at least one second entry in the at least one database, wherein the at least one second entry may be associated with the at least one first entry.

### TECHNICAL FIELD

Example embodiments of the present disclosure relate to simulating load for a load test.

### BACKGROUND

A telecommunication system may include one or more databases for managing and storing various types of information, such as information associated with network operations, user information, call detail records, and the like.

Within a database, the data or information may be organized into tables, each table may store specific types of information and may consist of rows and columns. A row of a table may be referred to as an “entry”, which represents a distinct entity and contains parameters corresponding to each column in the table. On the other hand, a column of the table may be referred to as a “field”, which represents an attribute or property of the data or information stored in the table. The entries in a database may be managed (e.g., retrieved, modified, deleted, etc.) via various querying techniques (e.g., Structured Query Language (SQL) command, etc.).

In a database of a telecommunication system, a transaction may refer to a set of operations initiated by a user (e.g., a network operator, a test engineer, etc.) and/or an application (e.g., database management system (DBMS), etc.) that involves management of data or information, such as managing user/subscriber information (e.g., updating a subscriber contact information, etc.), network configurations (e.g., inserting a device setting, etc.), call details (e.g., querying a call duration, etc.), and the like.

Further, in a telecommunication system, a single database may store similar or related information for provisioning of scalability, redundancy, fault tolerance, and load balancing. Furthermore, multiple databases may also store similar or related information due to similar reasons. The multiple databases may be distributed across different locations, servers, or network nodes.

### SUMMARY

Example embodiments of the present disclosure provide systems, apparatuses, methods, and the like, that simulate load for a load test on one or more databases.

According to embodiments, a system may include a load simulator. The load simulator may be configured to: generate at least one first transaction request associated with at least one first transaction for modifying at least one first entry in at least one database; provide, to the at least one database via a direct interface, the at least one first transaction request; and receive, from the at least one database via the direct interface, information associated with at least one second transaction for modifying at least one second entry in the at least one database, wherein the at least one second entry may be associated with the at least one entry.

According to embodiments, a method may include: generating at least one first transaction request associated with at least one first transaction for modifying at least one first entry in at least one database; providing, to the at least one database via a direct interface, the at least one first transaction request; and receiving, from the at least one database via the direct interface, information associated with at least one second transaction for modifying at least one second entry in the at least one database, wherein the at least one second entry may be associated with the at least one entry.

According to embodiments, a non-transitory computer-readable recording medium may have recorded thereon instructions executable by at least one server node to cause the at least one server node to perform a method including: generating at least one first transaction request associated with at least one first transaction for modifying at least one first entry in at least one database; providing, to the at least one database via a direct interface, the at least one first transaction request; and receiving, from the at least one database via the direct interface, information associated with at least one second transaction for modifying at least one second entry in the at least one database, wherein the at least one second entry may be associated with the at least one entry.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of an example system architecture associated with a database control system in the related art;

FIG. 2 illustrates a block diagram of a system architecture associated with a database control system that includes a load simulator, according to one or more embodiments;

FIG. 3 is a chart illustrating a comparison of transaction request execution rates in various embodiments and configurations;

FIG. 4 illustrates a flow sequence of operations for a load test of an intra-database synchronization, according to one or more embodiments;

FIG. 5 illustrates a block diagram of example components of a server node, according to one or more embodiments;

FIG. 6 illustrates a block diagram of an example configuration of a server node, according to one or more embodiments; and

FIG. 7 illustrates a diagram of an example environment 700 in which the systems and/or methods described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

As described above, in a telecommunication system, one or more databases may store similar or related information. In this regard, whenever the system receives a transaction request for modifying a data or information in a database, database synchronization may be required.

Specifically, a database may store a plurality of entries that are similar or related to each other. In this regard, when the database performs a transaction for modifying one of the entries, the associated entries may require to be modified in a similar manner to maintain consistency and avoid data/information discrepancies. For example, in a single database, a first entry set and a second entry set may each include a plurality of entries or may each include a shared entry. The shared entry of the first entry set and the shared entry of the second entry set may contain similar data or information. As such, a modification of the shared entry in the first entry set may be synchronized to the corresponding shared entry in the second entry set, or vice versa.

Similarly, a plurality of databases may each store a plurality of entries that are similar or related to each other. In this regard, when a database performs a transaction for modifying an entry, another database(s) may need to modify the associated entry to maintain consistency and avoid data/information discrepancies.

For descriptive purposes and brevity, some descriptions are provided hereinbelow with reference to intra-database synchronization. Nevertheless, it is contemplated that the principles and descriptions provided herein may be applicable to both inter-database synchronization and intra-database synchronization. For instance, the descriptions herein may be applicable to any of a plurality of databases each storing a single entry set, a single database storing a plurality of entry sets, a plurality of databases each storing a plurality of entry sets, and the like.

The database synchronization may be implemented by a synchronization function or a synchronization module in a database control system (e.g., DBMS, etc.) and may be triggered (e.g., by a triggering function or a triggering module, etc.) when required. In order to provide stable and reliable synchronization, testing on the database control system (particularly on the synchronization function) under a specific load is required.

Generally, the database control system may be tested by providing to said system one or more transaction requests at a given time, which may then generate an amount of load to the system. Accordingly, the system may be tested as to whether or not the amount of load can be handled without error or delay. This type of testing may be referred to as a “load test”, and may aim to demonstrate that the system can operate normally when the network activity reaches or exceeds a maximum expected level (e.g., a “peak load condition”).

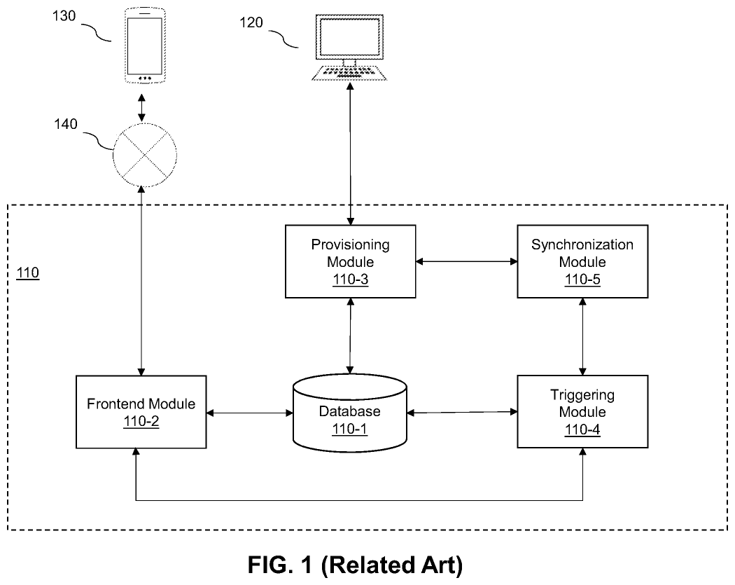

However, in the related art, it is unduly difficult (if not impossible) to accurately and effectively test the database control system (particularly on the synchronization function) under a specific load. Descriptions associated therewith are provided in the following with reference to FIG. 1.

FIG. 1 illustrates a block diagram of an example system architecture associated with a database control system in the related art. As illustrated in FIG. 1, the database control system 110 may include at least one database 110-1, at least one frontend module 110-2, at least one provisioning module 110-3, at least one triggering module 110-4, and at least one synchronization module 110-5. Further, at least one user equipment (UE) 130 may be communicatively coupled to the frontend module 110-2 of the database control system 110 via a network 140, and at least one administrative terminal 120 may be communicatively coupled to the provisioning module 110-3 of the databased control system 110.

It can be understood that the system architecture in FIG. 1 is simplified for descriptive purposes. In practice, the database control system 110 may manage a plurality of databases, or alternatively, a plurality of database control systems may be used, each operating a different database or a subset of the plurality of databases. Further, although the database 110-1 and modules 110-2 to 110-5 are depicted as part of the database control system 110, it can be understood that any suitable arrangement of these components between any number of physical components (e.g., a computer hardware) and/or virtual components (e.g., a software module), communicably coupled through the database control system 110, is within the scope of the disclosure. For example, the illustrated components within the database control system 110 may be implemented on the same physical computer server and executed on the same processor or processing core, or each may have its own dedicated processor or physical hardware which are networked together by any suitable connections, among other possible arrangements.

In general, the database 110-1 may receive, from the UE 130 and/or the administrative terminal 120, at least one transaction request for performing a transaction on a first information stored therein (e.g., modification on a first entry in the database 110-1, etc.). Accordingly, the database 110-1 may perform, based on the at least one transaction request, the transaction on the first information, and then provide the information of the transaction to the triggering module 110-4. The triggering module 110-4 may detect or determine whether or not a database synchronization is required, and then generate and provide a synchronization trigger to the synchronization module 110-5 when required. Accordingly, the synchronization module 110-5 may determine a synchronization to execute, and then generate and provide, to the provisioning module 110-3, at least one additional transaction request for synchronizing a second information associated with the first information (e.g., modification on a second entry in the database 110-1, etc.). Subsequently, the provisioning module 110-3 may execute the at least one additional transaction request, thereby synchronizing the information in the database 110-1 (e.g., modifying the second entry in a similar manner to how the first entry is modified).

In this regard, research has determined that, even if a load test may be performed for testing mainly the behavior or performance of the synchronization module 110-5, it is more desirable to induce the testing load by providing the transaction request(s) to the database 110-1, since doing so is more effective and accurate as compared to providing transaction request(s) to the synchronization module 110-5. Thus, the approaches for providing the transaction request(s) to the database 110-1 are closely related to the testing load.

Typically, a transaction request may travel through one or more components via a transaction path, before arriving at the database 110-1. For instance, the UE 130 may generate and provide at least one transaction request to a network 140 (or a component associated with the network 140, such as a network router, etc.), and the network 140 may route the transaction request to the frontend module 110-2 of the database control system 110. The frontend module 110-2 may provide an interface for receiving the transaction request from the network 140 and providing the transaction request to the database 110-1. Subsequently, the frontend module 110-2 may communicate with the triggering module 110-4 to coordinate the transaction. For instance, the triggering module 110-4 may confirm the transaction request was received and processed at the database 110-1, and may send a notification to the frontend module 110-2 such that the frontend module 110-2 may route the notification to the UE 130 to notify the associated user regarding the same.

Alternatively or additionally, the database 110-1 may receive at least one transaction request from the administrative terminal 120. Specifically, the administrative terminal 120 may generate and provide a transaction request to a provisioning module 110-3 of the database control system 110. The provisioning module 110-3 may provide an interface for receiving the transaction request from the administrative terminal 120 and providing the transaction request to the database 110-1. Subsequently, the provisioning module 110-3 may execute and/or provide the transaction request to the database 110-1.

The rate of receipt and execution of the transaction request may be defined in terms of “transaction per second” or “TPS”. In view of the above, in order to induce a specific amount of load for a load test, it is required to configure the database 110-1 to achieve a specific TPS at a specific time. Nevertheless, in the related art, it is difficult for the database control system 110 to achieve a specific TPS at a specific time. This is because, the transaction requests are provided by components external to the database control system 110 (e.g., the UE 130, the administrative terminal 120, etc.), and the number of transaction requests arriving at the database 110-1 (and the timing associated therewith) may be affected by the transaction path, the activity of the components, and the system protocol (e.g., how many requests is allowed for a component at one time, etc.).

For instance, the transaction request(s) provided by the UE 130 may pass through component(s) in the network 140 and the frontend module 110-2, before arriving at the database 110-1. In operation, this transaction path (may be referred to as the “first transaction path” herein) may be the path of the majority of load, in the form of real user activity, and the load associated therewith is likely to be unpredictable and uncontrollable as the timing and amount of user activity is unduly difficult (if not impossible) to be controlled. Further, typically, the frontend module 110-2 may not be configured to receive bulk requests from a single device (e.g., a single UE 130) to prevent malicious activity by users, and therefore the rate of transaction requests through the first transaction path is limited by the number of UE (or simulated devices, etc.) interacting with the frontend module 110-2. Furthermore, since the total number of UE potentially interacting with the frontend module 110-2 may be orders of magnitude larger than would be practical to prepare or simulate load for testing purposes, it is challenging to simulate the desired number of UE, and therefore the desired total TPS, to simulate or induce a specific load with traffic from the first transaction path.

Also as noted above, the transaction request(s) provided by the administrative terminal 120 may pass through the provisioning module 110-3, before arriving at the database 110-1. In operation, this transaction path (may be referred to as the “second transaction path” herein) may be utilized to provide or perform administrator activity to the database 110-1, and the traffic from the second transaction path is managed and processed with more complex protocols (e.g., more costly protocols, etc.) and may need to pass through component(s) like a gateway, which in turn causes latency in the response and load on the gateway itself. Further, the operations of the provisioning module 110-3 may be associated with each transaction request (or may be part of/preliminary to each request execution), and thus may be unnecessarily complex when the goal is to simply induce testing load in a controlled manner. For instance, when the provisioning module 110-3 is deployed in a vendor-operated server (may be referred to as “provisioning server” herein), the provisioning module 110-3 may authorize, execute, verify, supplement, and the like, each transaction request through several interrelated components, according to applicable networking and telecommunication standards, and may also provide broadly defined operations which take a larger number of parameters. In this case, the provisioning module 110-3 may also place a practical limit on the maximum TPS that may be induced at the synchronization module 110-3. Namely, while a large load may be generated at the administrative terminal 120, the load may reach a “bottleneck” at the provisioning module 110-3, due to this complex processing by each related component, any of which may have a different peak load condition. As a result, the rate of the load is greatly reduced when it finally arrives at the synchronization module 130.

In view of the above, in the related art, it is difficult to provide a specific amount of transaction requests to the database 110-1 at a specific time. Namely, it is difficult to induce a specific load according to a testing requirement, and as a result, it is difficult to perform a load test efficiently and accurately.

Example embodiments of the present disclosure provide a system, a method, a device, or the like, that simulate load for a load test. Specifically, example embodiments provide a load simulator configurable to generate at least one transaction request for modifying at least one entry of at least one database and then provide the at least one transaction request to the at least one database via a direct interface. The transaction request(s) provided by the load simulator may be simulated or customized for the load test, and may be provided directly to the database without passing through the transaction paths in the related art. Accordingly, example embodiments of the present disclosure enable a specific load to be simulated at a specific time, thereby enabling an efficient and accurate load test. Ultimately, example embodiments of the present disclosure enable efficient quality assurance (QA) related testing in a telecommunication system, thereby ensuring that the database synchronization function can operate under various loads.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations, as well as the technical advantages associated therewith, of example embodiments of the present disclosure are provided below.

### General System Architecture

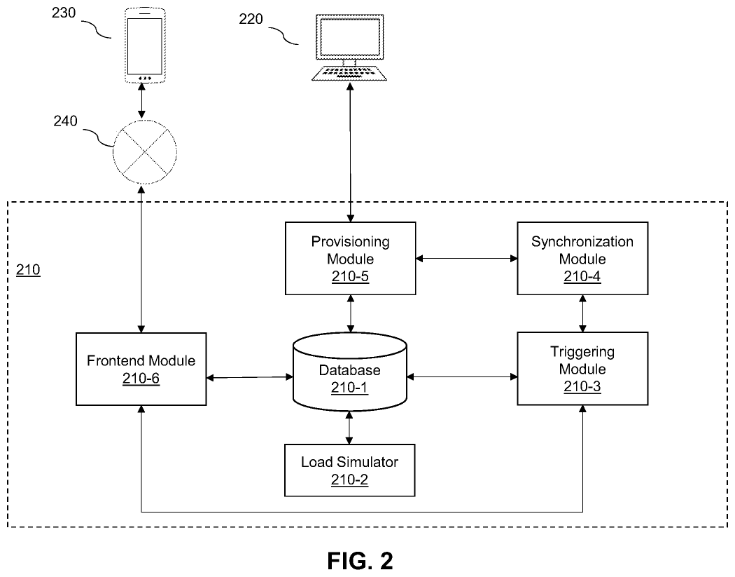

Descriptions of an example system architecture and the operations associated therewith, according to one or more embodiments, are provided in the following with reference to FIG. 2.

FIG. 2 illustrates a block diagram of a system architecture associated with a database control system that includes a load simulator, according to one or more embodiments. Referring to FIG. 2, the system architecture may include a database control system 210, which may include at least one database 210-1, at least one load simulator 210-2, at least one triggering module 210-3, at least one synchronization module 210-4, at least one provisioning module 210-5, and at least one frontend module 210-6. At least one administrative terminal 220 may be communicatively coupled to the provisioning module 210-5 of the database control system 210, and at least one user equipment (UE) 230 may be communicatively coupled to the frontend module 210-6 of the database control system 210 via a network 240.

It is contemplated that the configuration illustrated in FIG. 2 are provided for descriptive purposes, and the scope of the present disclosure should not be limited thereto. For instance, the database control system 210 may manage a plurality of databases, or alternatively, a plurality of database control systems may be used, each operating a different database or subset of the plurality of databases.

Further, although the database 210-1, the load simulator 210-2, and the modules 210-3 to 210-6 are depicted as part of the database control system 210, it can be understood that any suitable arrangement of these components between any number of physical components (e.g., a computer hardware) and/or virtual components (e.g., a software module), communicably coupled through the database control system 210, is within the scope of the disclosure. For example, all of the illustrated components within the database control system 210 may be implemented on the same physical computer server and executed on the same processor or processing core, or each may have its own dedicated processor or physical hardware which are networked together by any suitable connections, among other possible arrangements.

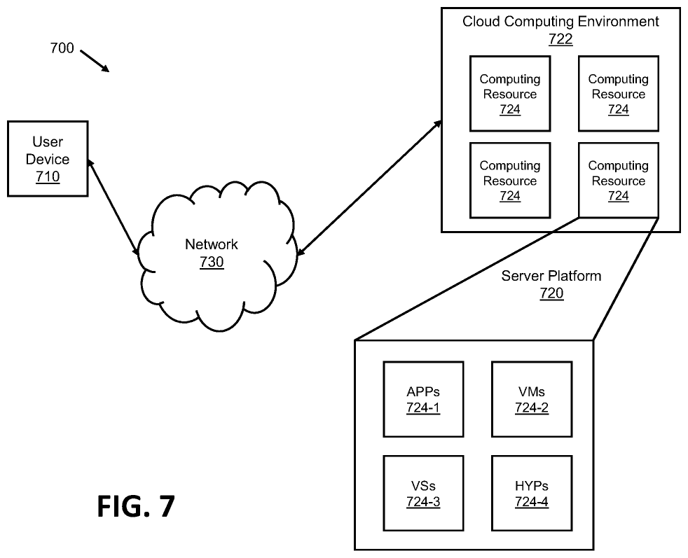

Additionally, it is contemplated that the administrative terminal 220 may also communicate with the database control system 210 via a network (e.g., the network 240, a network different from the network 240, etc.), without departing from the scope of the present disclosure. Descriptions of examples of the administrative terminal 220 and the UE 230 are provided below with reference to the user device 710 in FIG. 7, and descriptions of examples of the network 240 are provided below with reference to the network 730 in FIG. 7.

Furthermore, it can be understood that one or more of the components illustrated in FIG. 2 may not be involved in the operations of a load test. For instance, as further described below, in some embodiments, the load simulator 210-2 may provide a transaction request(s) to the database 210-1, without involving one or more of the frontend module 210-6, the administrative terminal 220, the UE 230, and the network 240. Thus, although it is contemplated the frontend module 210-6, the administrative terminal 220, the UE 230, and the network 240 may interoperate with other components in the database control system 210 in a similar manner as described above with reference to FIG. 1, the descriptions associated therewith may be omitted hereinbelow for conciseness.

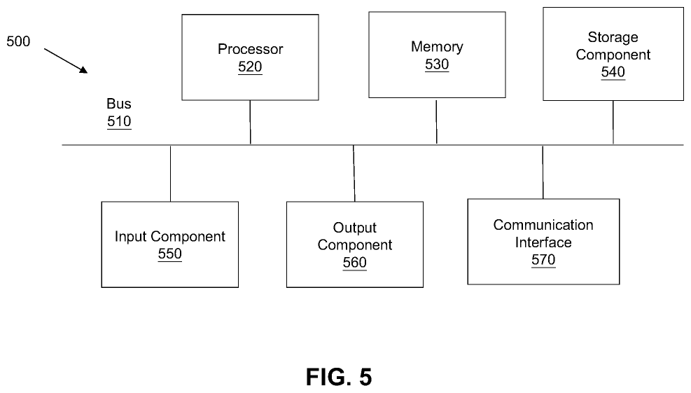

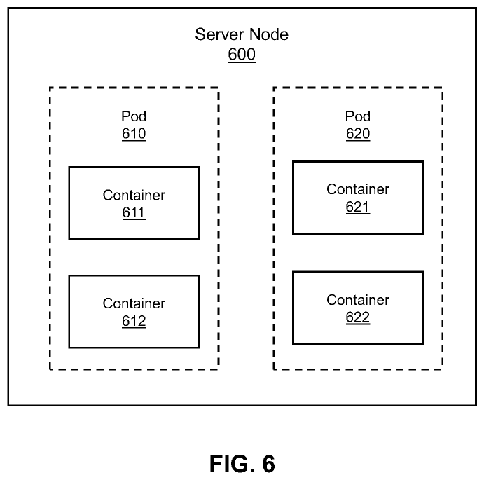

The database control system 210 may include a database control system (DBMS) that may be configured to manage and control the database 210-1. The database control system 210, and one or more components included therein, may be deployed in a software form and may be deployed or implemented in one or more server nodes. Example components of a server node in which the database control system 210 (and the component included therein) may be deployed or implemented are described below with reference to FIG. 5 and FIG. 6.

The database 210-1 may be a structured collection of data or information with predefined schemas, tables, and relationships. The database 210-1 may be stored in a memory or a storage of the system 210 (or a storage of the server node in which the system 210 is implemented). According to embodiments, the database 210-1 may include a plurality of databases, and a portion of the databases may be stored on different memories or storages.

The database 210-1 may contain information associated with network operations, user information, call detail records, and the like. According to embodiments, the database 210-1 may contain a plurality of account information entries, each describing identifiers, states, and configurations for an account of a user. Further, in some implementations, the database 210-1 may be a designated database for performing a load test and may receive transaction request(s) for the load test. The information in the database 210-1 may be managed (e.g., retrieved, modified, deleted, etc.) via various querying techniques (e.g., Structured Query Language (SQL) command, etc.).

A query, or a database transaction, may be performed by the database 210-1 upon receiving a transaction request. A transaction request may be provided in the form of a transaction signal and may contain instructions for a query. A query or transaction may be a data retrieval (“read”), a data modification (“write”), or both. A “read” transaction may not modify the contents of the database 210-1 directly. Nonetheless, the act of executing a transaction request may itself be stored to the database 210-1, in, for example, an access log or log table. Such logs may also be synchronized between the illustrated database 210-1 and other databases. For descriptive purposes, example embodiments of a “write” transaction modifying at least one database entry will be assumed going forward.

The load simulator 210-2 may be configured to generate at least one transaction request for modifying at least one entry in the database 210-1, and then provide the at least one transaction request to the database 210-1 via a direct interface. The load simulator 210-2 may be communicatively coupled to the database 210-1, communicatively coupled to a memory/storage storing the database 210-1, and/or communicatively coupled to a processor of the database control system 210 for managing the database 210-1.

According to embodiments, the load simulator 210-2, or one or more operations associated therewith, may be deployed or implemented in a software form, and may be deployed or implemented in a server node. According to embodiments, the load simulator 210-2 may be deployed or implemented in the same server in which the database 210-1 is deployed or implemented. Alternatively, the load simulator 210-2 may be deployed or implemented in a dedicated test server, which may be communicatively coupled to the database 210-1 (or a component/system storing thereof) by Lightweight Directory Access Protocol (LDAP) or any other suitable protocol. Likewise, the load simulator 210-2, or one or more operations associated therewith, may be executed by a processor or a processing core different from the database 210-1.

According to embodiments, the load simulator 210-2 may be configured to generate at least one transaction request based on at least one transaction template. The transaction template may define an outline, format, structure, and the like, of a transaction, and may be customized or configured by a user (e.g., a network operator, a test engineer, etc.) according to one or more test requirements. The transaction template may include placeholder parameters that would be replaced with actual parameters (e.g., testing parameters, etc.) by the load simulator 210-2 during the generation of the at least one transaction request. According to embodiments, the load simulator 210-2 may generate a plurality of transaction requests at a high TPS, thereby simulating or inducing a high testing load at the database 210-1. According to embodiments, the load simulator 210-2 may execute a script to automatically generate one or more transaction requests based on the transaction template. The script may define the logic or algorithm for generating the transaction request (e.g., how specifically the transaction template should be processed, how to replace or manipulate the placeholder parameters in the transaction template, how to modify the transaction template to adapt for different testing requirements, etc.), may be developed in any suitable scripting language (e.g., Pyhton, Java, etc.), and may be customized or configured by the user according to one or more test requirements.

According to embodiments, the load simulator 210-2 may be configured to generate at least one transaction request based on information of actual network traffic flow. For instance, the administrative terminal 220 and/or the UE 230 may provide a transaction request(s) to the database 210-1 (in a similar manner as described above with reference to FIG. 1), and the database 210-1 may perform a transaction(s) based thereon. In this regard, the load simulator 210-2 may obtain information of the transaction request(s) and/or the performed transaction(s), and may be configured to generate, based on the obtained information, the transaction request(s) for testing purposes when required.

According to embodiments, the transaction request(s) provided by the load simulator 210-2 may be simulated (rather than generated for actual execution). For instance, the transaction request(s) provided by the load simulator 210-2 may not make actual changes (or may only make temporal changes for testing purposes) to the contents of the database 210-1. Accordingly, the direct interface between the load simulator 210-2 and the database 210-1 may be simple and need not include many of the features or protocols which would normally be in place in other interfaces (e.g., interfaces of the provisioning module 210-5 and the frontend module 210-6, etc.). In some embodiments, the load simulator 210-2 may communicate with the database 210-1 by performing one or more native calls (e.g., native SQL calls, native Application Programming Interface (API) calls, etc.) to the database 210-1 via the direct interface.

In some implementations, the load simulator 210-2 may operate by multithreading. Multithreading is a technique by which multiple related operations may be conducted simultaneously in multiple threads. A thread is a lightweight process that shares the same resources and address space, allowing for parallel execution of tasks. For instance, each thread may generate and transmit a transaction request for faster operation.

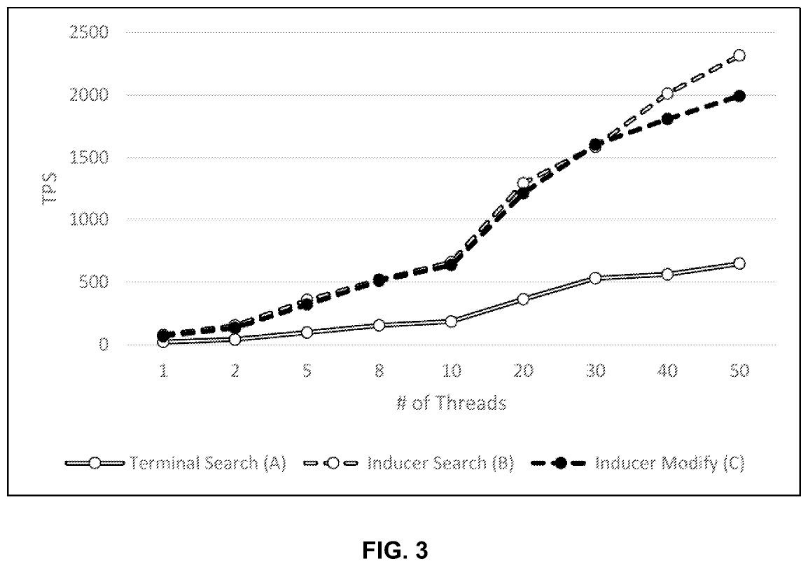

FIG. 3 is a chart illustrating a comparison of transaction request execution rates in various embodiments and configurations, as measured in TPS. The data in the chart is the result of transactions transmitted/executed over various numbers of threads under controlled conditions, using (A) a search function executed based on transaction requests received through a conventional interface from an administrative terminal (configured in accordance with administrative terminal 120 of the embodiments of FIG. 1 and providing the search transactions through the corresponding transaction path); (B) the same search function executed based on transaction requests received through a direct interface from a load simulator (configured in accordance with load simulator 210-2 of the embodiment of FIG. 2); and (C) a modification function executed based on transaction requests received through the direct interface from the load simulator.

As illustrated in FIG. 3, the rate for searches and modifications introduced through the load simulator in conditions (B) and (C) is noticeably faster than searches introduced through the administrative terminal in condition (A). This advantage is further realized as additional multithreading is provided, with the administrative terminal showing relatively minor improvement from increases in thread number, in comparison to the improvement seen by the same increases in thread number over the load simulator. Namely, it can be understood that a load simulator communicatively coupled to a database, such as illustrated in FIG. 2, can effectively induce a high transaction load, and the TPS associated therewith may be further improved by utilizing multithreading.

Referring back to FIG. 2, upon receiving the transaction request(s) from the load simulator 210-2, the database 210-1 may perform a transaction(s), such as a modification(s) on an entry stored within the database 210-1, based on the transaction request(s). Accordingly, the database 210-1 may provide, to the triggering module 210-3, information associated with the performed transaction(s).

The triggering module 210-3 may be deployed or implemented in a software form and may be deployed or implemented in a server node similar to or different from the database 210-1. Further, the triggering module 210-3 may be communicatively coupled to the database 210-1 (or a component/system storing thereof) by Hypertext Transfer Protocol (HTTP) or any other suitable protocol. Furthermore, the triggering module 210-3, or one or more operations associated therewith, may be executed by a processor or a processing core different from the database 210-1 and/or the load simulator 210-2.

According to embodiments, the triggering module 210-3 may be configured to receive, from the database 210-1, the information associated with a transaction(s) performed by the database 210-1, and then determine whether or not a synchronization due to the performed transaction(s) is required. Accordingly, based on determining that the synchronization is required, the triggering module 210-3 may determine whether the synchronization (if any) is required immediately or at a late time. Further, the triggering module 210-3 may further determine which information (e.g., which entry(s) of which table(s), etc.) of which database needs to be synchronized. In some implementations, the triggering module may detect an incoming or ongoing transaction at the database 210-1, and may determine (based on the content of the detected transaction) the type of transaction (e.g., “read”, “write”, etc.) and the entry(s) to which the transaction is directed.

According to embodiments, the triggering module 210-3 may generate, based on the information associated with the transaction(s), a synchronization trigger, and then provide the synchronization trigger to the synchronization module 210-4, thereby signaling the synchronization module 210-4 to activate and perform a required operation(s) for synchronizing at least one entry. The synchronization trigger may be a trigger signal that includes information describing what database entry(s) or data were altered in the database 210-1 during the transaction(s) performed by the database 210-1. In certain embodiments, the triggering module 210-3 may send the synchronization trigger in response to a modification of a particular or designated entry(s) (e.g., designated via flags or lookup tables, etc.). In other embodiments, the triggering module 210-3 may send the synchronization trigger in response to any modification of any entry(s).

The synchronization module 210-4 may be configured to receive, from the triggering module 210-3, the synchronization trigger, and then generate one or more additional transaction requests (may be referred to as a “synchronization transaction request” or a “second transaction request” herein) for synchronizing the modified entry(s). Accordingly, the synchronization module 210-4 may provide, to the provisioning module 210-5, the at least one synchronization transaction request.

Similar to the triggering module 210-3, the synchronization module 210-4 may be deployed or implemented in a software form and may be deployed or implemented in a server node similar to or different from the database 210-1. Further, the synchronization module 210-4 may be communicatively coupled to the triggering module 210-3 (or a component/system storing thereof) and the provisioning module 210-5 by HTTP or any other suitable protocol. Furthermore, the synchronization module 210-4, or one or more operations associated therewith, may be executed by a processor or a processing core different from the database 210-1, the load simulator 210-2, the triggering module 210-3, and/or the provisioning module 210-5.

According to embodiments, upon receiving the synchronization trigger, the synchronization module 210-4 may determine, based on logic, mapping tables, and/or any other suitable functions and data, what entry(s) in the database 210-1 (or in a different database) is associated with the modified entry(s) in the database 210-1 (e.g., entry(s) modified by the database 210-1 upon executing the transaction request(s) provided by the load simulator 210-2). For instance, the synchronization module 210-4 may determine that an entry in another database should be synchronized by reading the content(s) of the modified entry(s) in the database 210-1 and writing the entry in the another database in a similar manner. Accordingly, the synchronization module 210-4 may generate a synchronization transaction request(s) that instruct the provisioning module 210-5 to synchronize the associated entry(s). In some implementations, the synchronization module 210-4 may generate a plurality of synchronization requests and provide the same to the provisioning module 210-5, via multithreading.

The provisioning module 210-5 may be configured to receive, from the synchronization module 210-4, the synchronization transaction request(s), and then execute the synchronization transaction request(s) to perform a transaction for synchronizing an associated entry(s) (may be referred to as a “synchronization transaction” or a “second transaction” herein).

According to embodiments, the provisioning module 210-5 may execute the synchronization transaction request(s) to modify an entry(s) in a second database (that is different from the database 210-1) and/or to modify a second entry(s) (that is different from the modified entry(s)) in the database 210-1. In some implementations, the provisioning module 210-5 may, upon executing the synchronization transaction request(s), interoperate with one or more modules/components in the database control system 210 to synchronize the associated entry(s). For instance, the provisioning module 210-5 may generate a transaction instruction for instructing the database 210-1 and/or the second database to modify the entry(s), and then provide the transaction instruction to the database 210-1 and/or the second database.

Similar to the triggering module 210-3 and the synchronization module 210-4, the provisioning module 210-5 may be deployed or implemented in a software form and may be deployed or implemented in a server node similar to or different from the database 210-1.

As illustrated in FIG. 2, the provisioning module 210-5 may be communicatively coupled to the synchronization module 210-4, the database 210-1, and the administrative terminal 220. According to embodiments, the provisioning module 210-5 may be communicatively coupled to the synchronization module 210-4 (or a component/system storing thereof) and the administrative terminal 220 by HTTP or any other suitable protocol. Further, the provisioning module 210-5 may be communicatively coupled to the database 210-1 (or a component/system storing thereof) by LDAP or any other suitable protocol. Furthermore, the provisioning module 210-5, or one or more operations associated therewith, may be executed by a processor or a processing core different from the database 210-1, the load simulator 210-2, the triggering module 210-3, the provisioning module 210-5, and/or the synchronization module.

It is contemplated the provisioning module 210-5 may also be configured to interoperate with the administrative terminal 220 in a similar manner as described above with reference to FIG. 1, without departing from the scope of the present disclosure. Thus, the redundant descriptions associated therewith may be omitted hereinbelow for conciseness.

Upon performing a transaction for synchronizing on the associated entry(s), the associated database(s) may provide the information of the transaction to the load simulator 210-2. For instance, when the synchronization is an intra-database synchronization, the provisioning module 210-5 may execute the synchronization transaction request to modify or to instruct the database 210-1 to modify an entry(s) associated with the modified entry(s). Accordingly, the database 210-1 may perform a second transaction to modify the entry(s), and then provide information associated with the modification of the entry(s) (e.g., entry(s) associated with the modified entry(s), etc.) to the load simulator 210-2.

In this way, the load simulator 210-2 may determine, based on said information, a testing result indicating the behavior or performance database synchronization process (e.g., performance of the database 210-1, the triggering module 210-3, the synchronization module 210-4 and/or the provisioning module 210-5) responsive to the testing load caused by the transaction request(s) provided or simulated by the load simulator 210-2. According to embodiments, multiple load tests may be performed, and the load simulator 210-2 may receive or collect multiple testing results from the associated database(s). Subsequently, the load simulator 210-2 may compile the plurality of testing results into a testing report, which may include additional information such as derived test results like the rate of error, average delay, and so forth, as well as other analysis or information. Such will assist in evaluating the overall ability of the modules in the database control system 210 (e.g., the synchronization module 210-4, etc.) in managing the testing load generated by the load simulator 210-2.

In view of the above, example embodiments of the present disclosure provide a system that includes a load simulator, which may simulate or generate a transaction request(s) that induce a specific load for a load test, wherein the load simulator may interact more directly with the database to provide the transaction request(s) thereto without passing through complex transaction paths or external components as in the related art. Accordingly, example embodiments enable effective and efficient simulation or induction of testing load, and allow an accurate load test to be performed.

### Examples Operations

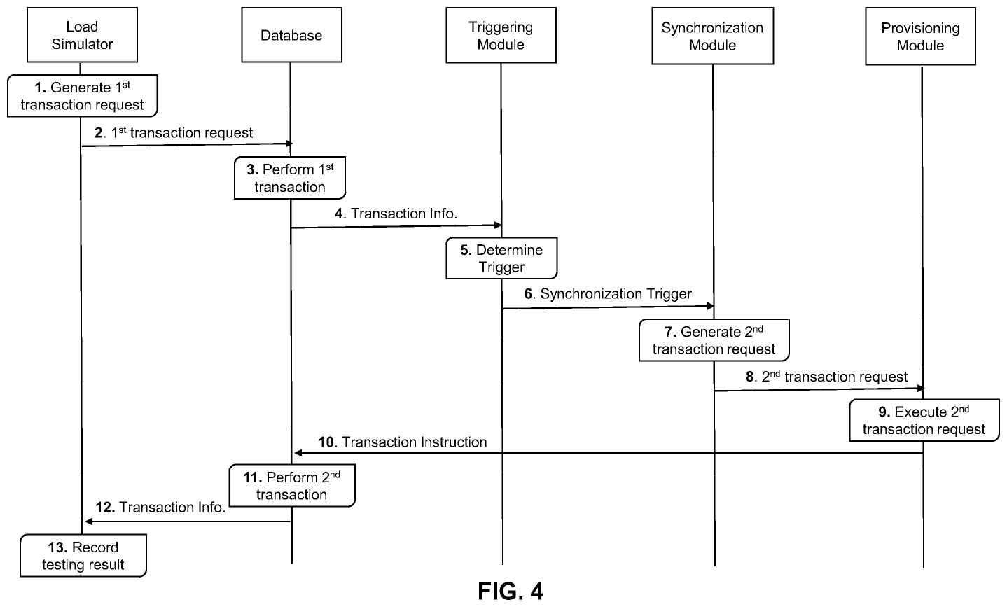

As described above, example embodiments of the present disclosure provide a system that includes a load simulator to simulate or induce load for a load test. The load test may be performed for testing a behavior or performance of an intra-database synchronization (i.e., synchronization between information or data within a single database) and an inter-database synchronization (i.e., synchronization between information or data among multiple databases). Descriptions of example operations associated with intra-database synchronization are provided in the following with reference to FIG. 4.

FIG. 4 illustrates a flow sequence of operations for a load test of an intra-database synchronization, according to one or more embodiments. One or more operations in FIG. 4 may be performed by a database control system (e.g., system 210 in FIG. 2). Specifically, as illustrated in FIG. 4, the flow sequence may involve at least one load simulator, at least one database, at least one triggering module, at least one synchronization module, and at least one provisioning module, each of which may be similar to the load simulator 210-2, the database 210-1, the triggering module 210-3, the synchronization module 210-4, and the provisioning module 210-5 in FIG. 2, respectively.

According to embodiments, one or more operations described herein, along with other necessary instructions or information, may be defined in computer-readable or computer-executable instructions, and may be stored in one or more non-transitory computer-readable medium (e.g., memory storage, etc.). Accordingly, said one or more operations may be performed by one or more processors upon executing the associated instructions. In some implementations, the operations associated with the load simulator, the database, the triggering module, the synchronization module, and the provisioning module may be performed by a dedicated processor or processing core. Descriptions of examples of the non-transitory computer-readable medium and the processor are provided below with reference to FIG. 5.

Referring to FIG. 4, at operation 1, the load simulator may be configured to generate at least one first transaction request for modifying at least one first entry in the database. Specifically, the load simulator may generate the at least one first transaction request based on a transaction template. Further, the load simulator may generate a plurality of first transaction requests simultaneously or consecutively. For instance, the load simulator may generate the plurality of first transaction requests by multithreading. Further, the load simulator may execute a script to automatically generate the at least one first transaction request based on the transaction template. Operations associated therewith have been described above with reference to FIG. 2, thus redundant descriptions associated therewith may be omitted below for conciseness.

According to embodiments, the generation of the at least one first transaction request may be triggered by a user (e.g., a network operator, a test engineer, etc.) via, for example, a device or equipment communicatively coupled to the load simulator, an input component of a server node in which the load simulator is deployed or implemented (further described below with reference to FIG. 5), and the like. Alternatively or additionally, the generation of the at least one first transaction request may be automatically triggered based on, for example, a pre-configured schedule (e.g., a scheduled load test, etc.).

At operation 2, the load simulator may be configured to provide the at least one first transaction request to the database. Specifically, the load simulator may provide, to the database via a direct interface, the at least one first transaction request. According to embodiments in which the at least one first transaction request includes a plurality of first transaction requests, the load simulator may provide the plurality of first transaction requests by multithreading. Operations associated therewith have been described above with reference to FIG. 2, thus redundant descriptions associated therewith may be omitted below for conciseness.

According to embodiments, the load simulator may provide the at least one first transaction request to a processor or a processing core associated with the database (may be referred to as a “database processor” herein), such as the processor or processing core executing the DBMS, and the like. For instance, when the load simulator is implemented or deployed in a test server different from a server implementing or deploying the database, a processor or a processing core associated with the load simulator (may be referred to as a “load simulator processor” herein) may provide the at least one first transaction request to the database processor through a communication interface (e.g., the direct interface, etc.)

At operation 3, the database may be configured to receive, from the load simulator via the direct interface, the at least one first transaction request. Accordingly, the database may perform, based on the at least one first transaction request, at least one first transaction for modifying the at least one first entry.

Next, at operation 4, the database may provide, to the triggering module, information associated with the at least one first transaction (may be referred to as “first transaction information” herein). According to embodiments, the first transaction information may include contents of the at least one modified first entry, information associated with the table of the at least one first entry, information associated with the database, and any other suitable information.

It is noted that, as of this point in the flow of operations, only the load simulator (or the processor associated therewith) and the database (or the processor associated therewith) have been involved in the operations. No intervening components have interacted with the at least one first transaction request. Further, the at least one first transaction request is directly provided to the database (or the processor associated therewith), thereby bypassing any complex transaction paths or components (e.g., administrative terminal 120, UE 130, network 140, frontend module 110-2, provisioning module 110-3, etc.) and avoiding the above-described delays in the related art systems or approaches.

Referring still to FIG. 4, at operation 5, the triggering module may be configured to receive, from the database, the first transaction information, and then generate a synchronization trigger based thereon. Specifically, the triggering module may detect or determine, based on the first transaction information, whether or not to trigger a database synchronization. Operations associated therewith have been described above with reference to FIG. 2, thus redundant descriptions thereof may be omitted below for conciseness. Further, it is noted that, for testing purposes, the at least one first transaction request simulated or generated by the load simulator (at operation 1) may be designed such that a synchronization is triggered.

At operation 6, the triggering module may be configured to provide, to the synchronization module, the synchronization trigger. Further, at operation 7, the synchronization module may be configured to receive, from the triggering module, the synchronization trigger, and then generate at least one second transaction request based thereon. According to embodiments, the synchronization module may generate a plurality of second transaction requests simultaneously or consecutively. For instance, the synchronization module may generate the plurality of second transaction requests by multithreading. Operations associated therewith have been described above with reference to FIG. 2, thus redundant descriptions thereof may be omitted below for conciseness.

At operation 8, the synchronization module may be configured to provide the at least one second transaction request to the provisioning module. At operation 9, the provisioning module may be configured to receive, from the synchronization module, the at least one second transaction request. Accordingly, the provisioning module may be configured to execute the at least one second transaction request to perform at least one second transaction for modifying at least one second entry in the database. For instance, the provisioning module may generate a transaction instruction (e.g., a “write” instruction, etc.) for instructing the database to modify the at least one second entry. Alternatively, the provisioning module may simply route the at least one second transaction request to the database, such that the database may process the at least one second transaction request to modify the at least one second entry accordingly.

Assuming that the provisioning module generates the transaction instruction (at operation 9), at operation 10, the provision module may provide the transaction instruction to the database. Accordingly, at operation 11, the database may be configured to receive, from the provisioning module, the transaction instruction, and then perform the at least one second transaction to modify the at least one second entry based thereon. Subsequently, the database may provide the information associated with the at least one second transaction to the load simulator.

At operation 12, the load simulator may be configured to receive, from the database, the information associated with the at least one second transaction. Accordingly, the load simulator may record the information as a testing result. Alternatively or additionally, another module or other component may detect and record the synchronization. This other component may be a module illustrated in FIG. 4, or may be another component. As one example, the database itself may log and timestamp each synchronization operation, and this log may then be analyzed at a later time by any device or component that may access the log.

The operations described above with respect to FIG. 4 may be performed repeatedly in a concurrent or near-concurrent manner, due to the involvement of multiple processors and, in some embodiments, multithreading. For example, as described above, operations 1 and 2 in FIG. 4 may be performed by multithreading, in which several performances of said operations may occur at the same time.

After a sufficient number of performances of the operations of FIG. 4 as a whole, a set of testing results of individual synchronizations may be compiled into a testing report, which may further include derived test results such as rate of error, average delay, and so forth, as well as other analysis. Such will assist in evaluating the overall ability of the database control system to manage the load simulated or generated by the load simulator.

In view of the above, example embodiments of the present disclosure may provide the transaction request(s) for simulating or inducing load for a load test without involving a transaction request, transaction paths, or other activity from component(s) external to the database control system (e.g., UE, administrative terminal, etc.), as in the related art systems or approaches. Accordingly, example embodiments of the present disclosure enable a specific TPS at a specific time, thereby enabling a specific testing load to be induced or simulated as per requirement, and avoiding the delay and uncertainty nature in provisioning the testing load in the related art.

### Examples of Server Node

As described above, one or more components/modules of the database control system (or one or more operations associated therewith) may be deployed or implemented in one or more server nodes, according to one or more embodiments. Descriptions of an example server node are provided in the following with reference to FIG. 5 and FIG. 6.

FIG. 5 illustrates a block diagram of example components of a server node 500, according to one or more embodiments. Server node 500 may have one or more components/modules of the database control system (system 210 in FIG. 2) deployed or implemented therein. As shown in FIG. 5, server node 500 may include at least one bus 510, at least one processor 520, at least one memory 530, at least one storage component 540, at least one input component 550, at least one output component 560, and at least one communication interface 570.

Bus 510 may include a component that enables communication among the components of server node 500. For instance, the bus 510 may include a system bus (e.g., a front side bus (FSB), a quick path interconnect (QPI), etc.), a peripheral component interconnect express (PCIe), a memory bus, a storage bus, and the like, that enable efficient flow of data and information between the components of the server node 500.

Processor 520 may be implemented in hardware, firmware, or a combination of hardware and software. Processor 520 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 may include one or more processors capable of being programmed to perform a function. For instance, the processor 520 may include a first processor or a first processing unit dedicated for executing the load simulator and performing an operation(s) associated therewith, and may include second processor or a second processing unit dedicated for managing the database and performing an operation(s) associated therewith. Similarly, the processor 520 may include a plurality of processor or processing units, each of which may be dedicated to the triggering module, the synchronization module, the provisioning module, and the like, without departing from the scope of the present disclosure.

Memory 530 may include a random access memory (RAM), a read-only memory (ROM), an erasable programmable read-only memory (EPROM), and/or another type of dynamic or static storage device (e.g., a flash memory, a magnetic memory, and/or an optical memory) that stores information and/or instructions for use by processor 520. For instance, the memory 530 may store computer-readable or computer-executable instructions for implementing the load simulator and/or other modules in the database control system (e.g., triggering module, synchronization module, provisioning module).

Storage component 540 may store information and/or software related to the operation and use of the components of the server node 500. For example, the storage component 540 may include a hard disk (e.g., a magnetic disk, an optical disk, a magneto-optic disk, and/or a solid state disk), a compact disc (CD), a digital versatile disc (DVD), a memory stick, a floppy disk, a cartridge, a magnetic tape, and/or another type of non-transitory computer-readable medium, along with a corresponding drive.

According to embodiments in which the server node 500 is configured to deploy or implement the database, the storage component 540 may include the information or data of the database (e.g., information associated with network operations, user information, call detail record, etc.) in the form of, for example, tables, as described above with reference to database 210-1 of FIG. 2.

Further, similar to the memory 530, the storage component 540 may store computer-readable or computer-executable instructions for implementing the load simulator and/or other modules in the database control system (e.g., triggering module, synchronization module, provisioning module). Specifically, the storage component 540 may provide the computer-executable instructions to the memory 530 when required. Additionally or alternatively, the computer-readable or computer-executable instructions may be read into memory 530 and/or storage component 540 from another computer-readable medium or from another device via communication interface 570 when required.

Input component 550 may include a component that permits the server node 500 to receive information, such as via user input (e.g., a touch screen display, a keyboard, a keypad, a mouse, a button, a switch, and/or a microphone). For instance, according to embodiments in which the load simulator is deployed or implemented in the server node 500, the input component 550 may receive, from a user (e.g., a network operator, a test engineer, etc.), a user input that triggers the load test (e.g., trigger the flow sequence of FIG. 4, etc.). Additionally, or alternatively, input component 550 may include a sensor for sensing information (e.g., a global positioning system (GPS) component, an accelerometer, a gyroscope, and/or an actuator).

Output component 560 may include a component that provides output information from device 500 (e.g., a display, a speaker, and/or one or more light-emitting diodes (LEDs)). For instance, the output component 560 may present, to the user, a status of a load test, a testing result, and the like.

Communication interface 570 may include a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 570 may include one or more application programming interfaces (APIs) that allow the server node 510 (or one or more components included therein) to communicate with one or more software applications (e.g., software application deployed in an administrative terminal, etc.). Further, according to embodiments in which the module(s) of the database control system are defined in the software form, the API(s) may enable the modules to communicate with one another.

According to embodiments in which the load simulator is deployed or implemented in the server node 500, the communication interface 570 may include a direct interface that enables the load simulator to communicate with a database (or a component of a server node in which the database is implemented), as described above with reference to FIG. 2.

Server node 500 may perform one or more operations described herein. Specifically, server node 500 may perform said operation(s) or process in response to the processor 520 executing computer-readable or computer-executable instructions stored by a non-transitory computer-readable medium, such as memory 530 and/or storage component 540. A computer-readable medium may be defined herein as a non-transitory storage medium or a non-transitory memory device. A memory device includes memory space within a single physical storage device or memory space spread across multiple physical storage devices.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, the server node 500 may include additional components, fewer components, different components, or differently arranged components than those shown in FIG. 5. Additionally, or alternatively, a set of components (e.g., one or more components) of server node 500 may perform one or more functions described as being performed by another set of components of server node 500.

In some embodiments, any one of the operations or processes of FIGS. 2 and 4 may be implemented by or using any one of the elements illustrated in FIG. 5. It is understood that other embodiments are not limited thereto, and may be implemented in a variety of different architectures (e.g., bare metal architecture, any cloud-based architecture or deployment architecture such as Kubernetes, Docker, OpenStack, etc.).

According to embodiments, the database control system (or one or more components and operations associated therewith) may be implemented in the form of a containerized function. Below, an example configuration for implementing the containerized function is provided.

FIG. 6 illustrates a block diagram of an example configuration of a server node 600, according to one or more embodiments. The server node 600 may correspond to the server node 500 in FIG. 5, and may be configured to implement one or more server platforms (descriptions of example embodiment associated therewith are provided below with reference to FIG. 7).

According to embodiments, the database control system described herein (or one or more components and operations associated therewith) may be defined in software form via, for example, containerization (or any other suitable technology). Accordingly, the containerized database control system may be deployed, in the form of containers, in the network node 600, and the functionalities/operations associated therewith may be performed via execution or orchestration of the associated containers.

As illustrated in FIG. 6, the server node 600 may include a plurality of containers 611-612 and 621-622. The containerized database control system may be disaggregated or scattered among the plurality of containers 611-612 and 621-622. For instance, the functionalities or operations associated with the load simulator may be scattered among the containers 611-612, while the functionalities or operations associated with the database (or other modules such as the triggering module, the synchronization module, and the provisioning module) may be scattered among the containers 621-622.

Additionally or alternatively, the containerized database control system may be segregated according to the type of operations. For instance, the functionalities or operations associated with a transaction(s) for normal database operations may be scattered among the containers 611-612, while the functionalities or operations associated with a transaction(s) for inducing or simulating load for a load test may be scattered among the containers 621-622.

According to embodiments, the network node 600 may include a Kubernetes (K8s) node, and the containers may be grouped or aggregated in a respective pod. In the example embodiment of FIG. 6, the containers 611-612 are included in a first pod 610, while the containers 621-622 are included in a second pod 620.

The plurality of pods in the network node 600 may share the same resources (e.g., CPU, memory, etc.) provided by the network node 600. The resources being allocated for simulating load for the load test may be managed by adjusting the associated pods and/or containers. For instance, the resources may be scaled up by increasing the number of containers and/or pods associated therewith, may be scaled down by decreasing the number of containers and/or pods associated therewith, or the like.

It can be understood that the configuration illustrated in FIG. 6 is simplified for descriptive purposes, and is not intended to limit the scope of the present disclosure. Specifically, in practice, the network node 600 may include any suitable components for hosting and executing a plurality of pods, while the number of pods may be greater than two and the number of containers included in each pod may be greater than two, without departing from the scope of the present disclosure. Further, it can be understood that the containerized database control system (or the components and operations associated therewith) may be hosted or deployed in a plurality of network nodes, in a similar manner as described above. Furthermore, it can be understood that multiple nodes may include the same containers (or pods) in order to provide network redundancy thereby improving the network availability.

To this end, example embodiments of the present disclosure may provide one or more server nodes in which the database control system of example embodiments may be implemented and deployed or be implemented.

Further, example embodiments of the present disclosure may leverage the advantages of containerization in simulating load for the load test. For instance, implementing a containerized database control system (or components and operations associated therewith) offers improved scalability, since the functionalities may be efficiently scaled according to demand and may be easily replicated and orchestrated across multiple nodes, thereby enabling efficient resource utilization and seamless scaling.

Further, the containerized database control system (or components and operations associated therewith) may be quickly instantiated, migrated, and updated, allowing for faster time-to-market for new services and features. Furthermore, the functionalities of the database control system may be managed by adjusting the associated containers, thereby enabling independent development, testing, and deployment of the operations.

In addition, implementing the containerized database control system (or components and operations associated therewith) may also improve resource utilization efficiency, utilize container-specific security features to improve the system security, provide improved portability and interoperability, and enable seamless integration with different systems or platforms.

### Example of Implementation Environment

As described above, according to embodiments, the database control system (or components and operations associated therewith) may be implemented in one or more server nodes, which may include a cloud server or a cloud server cluster. Descriptions of an example cloud environment, in which the example embodiments may be implemented, are provided below with reference to FIG. 7.

FIG. 7 illustrates a diagram of an example environment 700 in which the systems and/or methods described herein, may be implemented. As illustrated in FIG. 7, environment 700 may include a user device 710, a server platform 720, and a network 730. Devices of environment 700 may interconnect via wired connections, wireless connections, or a combination of wired and wireless connections. In embodiments, any of the functions and operations described with reference to any of the above figures may be performed by any combination of elements illustrated in FIG. 7.

The user device 710 may include one or more devices or equipment capable of receiving, generating, storing, processing, and/or providing information associated with platform 720. For example, user device 710 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or any other suitable device. In some implementations, user device 710 may receive information from and/or transmit information to platform 720. The user device 710 may be similar to the user equipment (UE) 230 and/or the administrative terminal 220 in FIG. 2.

The network 730 may include one or more wired and/or wireless networks. For example, the network 730 may include a cellular network (e.g., a fifth generation (5G) network, a sixth generation (6G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks. Additionally or alternatively, the network 730 may be implemented as one or more of various types of networks, such as intranet, Closed Area Network (CAN), and the like. Further, the network 730 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), and the like, to communicate with each other. Further, the network 730 may include a variety of network devices, including routers, bridges, servers, computing devices, storage devices, and the like. The network 730 may be similar to the network 240 in FIG. 2.

The server platform 720 includes one or more servers capable of receiving, generating, storing, processing, and/or providing information. According to embodiments, the server platform 720 may include one or more network nodes described above with reference to FIG. 5 and FIG. 6. In some implementations, server platform 720 may include a cloud server or a group of cloud servers.

In some implementations, the server platform 720 may be designed to be modular such that certain software components may be swapped in or out depending on a particular need. As such, the server platform 720 may be easily and/or quickly reconfigured for different uses.

In some implementations, as shown, the server platform 720 may be hosted in cloud computing environment 722. Notably, while implementations described herein describe the server platform 720 as being hosted in cloud computing environment 722, in some implementations, platform 720 may not be cloud-based (i.e., may be implemented outside of a cloud computing environment) or may be partially cloud-based.

Cloud computing environment 722 includes an environment that hosts the server platform 720. Cloud computing environment 722 may provide computation, software, data access, storage, and services that do not require end-user knowledge of a physical location and configuration of system(s) and/or device(s) that hosts the server platform 720. As shown, cloud computing environment 722 may include a group of computing resources 724 (referred to collectively as “computing resources 724” and individually as “computing resource 724”).

Computing resource 724 may include one or more personal computers, a cluster of computing devices, workstation computers, server devices, or other types of computation and/or communication devices. In some implementations, the computing resource 724 may host the server platform 720. The cloud resources may include instances computing and executing in the computing resource 724, storage devices provided in the computing resource 724, data transfer devices provided by the computing resource 724, and the like. In some implementations, the computing resource 724 may communicate with other computing resources 724 via wired connections, wireless connections, or a combination of wired and wireless connections.

As further shown in FIG. 7, the computing resource 724 includes a group of cloud resources, such as one or more applications (“APPs”) 724-1, one or more virtual machines (“VMs”) 724-2, virtualized storage (“VSs”) 724-3, one or more hypervisors (“HYPs”) 724-4, or the like.

The application 724-1 may include one or more software applications that may be provided to or accessed by the user device 710. The application 724-1 may eliminate the need to install and execute the software applications on the user device 710. For example, the application 724-1 may include software associated with the server platform 720 and/or any other software capable of being provided via cloud computing environment 722. In some implementations, one application 724-1 may send/receive information to/from one or more other applications 724-1, via virtual machine 724-2.

The virtual machine 724-2 may include a software implementation of a machine (e.g., a computer) that executes programs like a physical machine. Virtual machine 724-2 may be either a system virtual machine or a process virtual machine, depending upon the use and degree of correspondence to any real machine by the virtual machine 724-2. A system virtual machine may provide a complete system platform that supports the execution of a complete operating system (“OS”). A virtual machine may execute a single program, and may support a single process. In some implementations, virtual machine 724-2 may execute on behalf of a user (e.g., a user associated with the user device 710), and may manage infrastructure and/or configuration of cloud computing environment 722, such as data management, synchronization, or long-duration data transfers.

Virtualized storage 724-3 may include one or more storage systems and/or one or more devices that use virtualization techniques within the storage systems or devices of computing resource 724. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 724-4 may provide hardware virtualization techniques that allow multiple operating systems (e.g., “guest operating systems”) to execute concurrently on a host computer, such as computing resource 724. The hypervisor 724-4 may present a virtual operating platform to the guest operating systems, and may manage the execution of the guest operating systems. Multiple instances of a variety of operating systems may share virtualized hardware resources.

It is contemplated that the number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

According to embodiments, the database control system (or one or more components and operations associated therewith) described herein may be implemented or be deployed in the server platform 720 described above, in the form of virtualized network function (VNF). In this regard, it is contemplated that the terms “virtual”, “virtualized”, or the like, described hereinabove are merely intended to specify the nature of the machine (and the elements and resources associated therewith) being provided in virtual or software form. In this regard, the “virtual machine”, “virtualized storage”, and the like, described hereinabove should not be limited to any specific type of virtual machine or virtual element. Accordingly, it can be understood that the database control system (or one or more components and operations associated therewith) may be defined or presented in the form of a containerized network function, of which the functions may be provided in the form of containers. Descriptions of an example implementation configuration for implementing the (or operations associated therewith) in the form of a containerized function have been provided above with reference to FIG. 6.

To this end, by virtualizing and implementing the database control system (or one or more components and operations associated therewith) in the server platform 720, the resources (e.g., processing power, memory, storage, etc.) for simulating load for a load test may be easily managed and be dynamically scaled up or scaled down on demand, which in turn optimize the resource allocation and utilization. Furthermore, said data and information associated with the database control system (or one or more components and operations associated therewith) may be easily cloned or backed up to provide redundancy, and the access of said data and information may be authorized and authenticated to a trusted entity only.

### Various Aspects of Embodiments

It is contemplated that the example embodiments described hereinabove with reference to FIG. 2 to FIG. 7 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., server node ode, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A system that may include a load simulator. The load simulator may be configured to: generate at least one first transaction request associated with at least one first transaction for modifying at least one first entry in at least one database; provide, to the at least one database via a direct interface, the at least one first transaction request; and receive, from the at least one database via the direct interface, information associated with at least one second transaction for modifying at least one second entry in the at least one database, wherein the at least one second entry may be associated with the at least one first entry.
Item [2]: The system according to item [1], wherein the load simulator may be configured to generate the at least one first transaction request by: obtaining a transaction template; and generating the at least one first transaction request based on the transaction template.
Item [3]: The system according to any one of items [1]-[2], wherein the at least one first transaction request may include a plurality of first transaction requests, and wherein the load simulator may be configured to generate the plurality of first transaction requests by multithreading.
Item [4]: The system according to item [3], wherein the load simulator may be configured to provide the plurality of first transaction requests by multithreading.
Item [5]: The system according to any one of items [1]-[4], wherein the system may further include the at least one database. The at least one database may be configured to: receive, from the load simulator via the direct interface, the at least one first transaction request; perform, based on the at least one first transaction request, the at least one first transaction for modifying the at least first one entry; and provide, to a triggering module, information associated with the at least one first transaction.
Item [6]: The system according to item [5], wherein the system may further include the triggering module. The triggering module may be configured to: receive, from the at least one database, the information associated with the at least one first transaction; generate, based on the information associated with the at least one first transaction, a synchronization trigger; and provide, to a synchronization module, the synchronization trigger.
Item [7]: The system according to item [6], wherein the system may further include the synchronization module. The synchronization module may be configured to: receive, from the triggering module, the synchronization trigger; generate, based on the synchronization trigger, at least one second transaction request for modifying the at least one second entry; and provide, to a provisioning module, the at least one second transaction request.
Item [8]: The system according to item [7], wherein the system may further include the provisioning module. The provisioning module may be configured to: receive, from the synchronization module, the at least one second transaction request; and execute the at least one second transaction request to perform at least one second transaction for modifying the at least one second entry in the at least one database.
Item [9]: The system according to item [8], wherein the provisioning module may be configured to execute the at least one second transaction request to perform the at least one second transaction by: generating a transaction instruction for instructing the at least one database to modify the at least one second entry; and providing, to the at least one database, the transaction instruction.
Item [10]: The system according to item [9], wherein the at least one database may be configured to: receive, from the provisioning module, the transaction instruction; perform, based on the transaction instruction, the at least one second transaction to modify the at least one second entry; and provide, to the load simulator, the information associated with the at least one second transaction.
Item [11]: A method including: generating at least one first transaction request associated with at least one first transaction for modifying at least one first entry in at least one database; providing, to the at least one database via a direct interface, the at least one first transaction request; and receiving, from the at least one database via the direct interface, information associated with at least one second transaction for modifying at least one second entry in the at least one database, wherein the at least one second entry may be associated with the at least one first entry.
Item [12]: The method according to item [11], wherein the generating the at least one first transaction request may include: obtaining a transaction template; and generating the at least one first transaction request based on the transaction template.
Item [13]: The method according to any one of items [11]-[12], wherein the at least one first transaction request may include a plurality of first transaction requests, and wherein the generating the at least one first transaction request may include: generating the plurality of first transaction requests by multithreading.
Item [14]: The method according to item [13], wherein the providing the at least one first transaction request may include: providing the plurality of first transaction requests by multithreading.
Item [15]: The method according to any one of items [11]-[14], further including: receiving, from a load simulator via the direct interface, the at least one first transaction request; performing, based on the at least one first transaction request, the at least one first transaction for modifying the at least first one entry; and providing, to a triggering module, information associated with the at least one first transaction.
Item [16]: The method according to item [15], further including: receiving, from the at least one database, the information associated with the at least one first transaction; generating, based on the information associated with the at least one first transaction, a synchronization trigger; and providing, to a synchronization module, the synchronization trigger.
Item [17]: The method according to item [16], further including: receiving, from a triggering module, the synchronization trigger; generating, based on the synchronization trigger, at least one second transaction request for modifying the at least one second entry; and providing, to a provisioning module, the at least one second transaction request.
Item [18]: The method according to item [17], further including: receiving, from the synchronization module, the at least one second transaction request; and executing the at least one second transaction request to perform at least one second transaction for modifying the at least one second entry in the at least one database.
Item [19]: The method according to item [18], wherein the executing the at least one second transaction request to perform the at least one second transaction may include: generating a transaction instruction for instructing the at least one database to modify the at least one second entry; performing, based on the transaction instruction, the at least one second transaction to modify the at least one second entry; and providing, to the load simulator, the information associated with the at least one second transaction.
Item [20]: A non-transitory computer-readable recording medium having recorded thereon instructions executable by at least one server node to cause the at least one server node to perform a method including: generating at least one first transaction request associated with at least one first transaction for modifying at least one first entry in at least one database; providing, to the at least one database via a direct interface, the at least one first transaction request; and receiving, from the at least one database via the direct interface, information associated with at least one second transaction for modifying at least one second entry in the at least one database, wherein the at least one second entry may be associated with the at least one first entry.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a load simulator configured to:
generate at least one first transaction request associated with at least one first transaction for modifying at least one first entry in at least one database;
provide, to the at least one database via a direct interface, the at least one first transaction request; and
receive, from the at least one database via the direct interface, information associated with at least one second transaction for modifying at least one second entry in the at least one database, wherein the at least one second entry is associated with the at least one first entry.

2. The system according to claim 1, wherein the load simulator is configured to generate the at least one first transaction request by:
obtaining a transaction template; and
generating the at least one first transaction request based on the transaction template.

3. The system according to claim 1, wherein the at least one first transaction request comprises a plurality of first transaction requests, and wherein the load simulator is configured to generate the plurality of first transaction requests by multithreading.

4. The system according to claim 3, wherein the load simulator is configured to provide the plurality of first transaction requests by multithreading.

5. The system according to claim 1, wherein the system further comprises the at least one database, wherein the at least one database is configured to:
receive, from the load simulator via the direct interface, the at least one first transaction request;
perform, based on the at least one first transaction request, the at least one first transaction for modifying the at least first one entry; and
provide, to a triggering module, information associated with the at least one first transaction.

6. The system according to claim 5, wherein the system further comprises the triggering module, wherein the triggering module is configured to:
receive, from the at least one database, the information associated with the at least one first transaction;
generate, based on the information associated with the at least one first transaction, a synchronization trigger; and
provide, to a synchronization module, the synchronization trigger.

7. The system according to claim 6, the system further comprises the synchronization module, wherein the synchronization module is configured to:
receive, from the triggering module, the synchronization trigger;
generate, based on the synchronization trigger, at least one second transaction request for modifying the at least one second entry; and
provide, to a provisioning module, the at least one second transaction request.

8. The system according to claim 7, the system further comprises the provisioning module, wherein the provisioning module is configured to:
receive, from the synchronization module, the at least one second transaction request; and
execute the at least one second transaction request to perform at least one second transaction for modifying the at least one second entry in the at least one database.

9. The system according to claim 8, wherein the provisioning module is configured to execute the at least one second transaction request to perform the at least one second transaction by:
generating a transaction instruction for instructing the at least one database to modify the at least one second entry; and
providing, to the at least one database, the transaction instruction.

10. The system according to claim 9, wherein the at least one database is configured to:
receive, from the provisioning module, the transaction instruction;
perform, based on the transaction instruction, the at least one second transaction to modify the at least one second entry; and
provide, to the load simulator, the information associated with the at least one second transaction.

11. A method comprising:
generating at least one first transaction request associated with at least one first transaction for modifying at least one first entry in at least one database;
providing, to the at least one database via a direct interface, the at least one first transaction request; and
receiving, from the at least one database via the direct interface, information associated with at least one second transaction for modifying at least one second entry in the at least one database, wherein the at least one second entry is associated with the at least one first entry.

12. The method according to claim 11, wherein the generating the at least one first transaction request comprises:
obtaining a transaction template; and
generating the at least one first transaction request based on the transaction template.

13. The method according to claim 11, wherein the at least one first transaction request comprises a plurality of first transaction requests, and wherein the generating the at least one first transaction request comprises:
generating the plurality of first transaction requests by multithreading.

14. The method according to claim 13, wherein the providing the at least one first transaction request comprises:
providing the plurality of first transaction requests by multithreading.

15. The method according to claim 11, further comprising:
receiving, from a load simulator via the direct interface, the at least one first transaction request;
performing, based on the at least one first transaction request, the at least one first transaction for modifying the at least first one entry; and
providing, to a triggering module, information associated with the at least one first transaction.

16. The method according to claim 15, further comprising:
receiving, from the at least one database, the information associated with the at least one first transaction;
generating, based on the information associated with the at least one first transaction, a synchronization trigger; and
providing, to a synchronization module, the synchronization trigger.

17. The method according to claim 16, further comprising:
receiving, from a triggering module, the synchronization trigger;
generating, based on the synchronization trigger, at least one second transaction request for modifying the at least one second entry; and
providing, to a provisioning module, the at least one second transaction request.

18. The method according to claim 17, further comprising:
receiving, from the synchronization module, the at least one second transaction request; and
executing the at least one second transaction request to perform at least one second transaction for modifying the at least one second entry in the at least one database.

19. The method according to claim 18, wherein the executing the at least one second transaction request to perform the at least one second transaction comprises:
generating a transaction instruction for instructing the at least one database to modify the at least one second entry;
performing, based on the transaction instruction, the at least one second transaction to modify the at least one second entry; and
providing, to the load simulator, the information associated with the at least one second transaction.

20. A non-transitory computer-readable recording medium having recorded thereon instructions executable by at least one server node to cause the at least one server node to perform a method comprising:
generating at least one first transaction request associated with at least one first transaction for modifying at least one first entry in at least one database;
providing, to the at least one database via a direct interface, the at least one first transaction request; and
receiving, from the at least one database via the direct interface, information associated with at least one second transaction for modifying at least one second entry in the at least one database, wherein the at least one second entry is associated with the at least one first entry.
